(19) United States
(12) Patent Application Publication
(10) Pub. No.: US 2018/0221993 A1
(43) Pub. Date: Aug. 9, 2018

(54) ALUMINUM ALLOY, EXTRUDED TUBE FORMED FROM ALUMINUM ALLOY, AND HEAT EXCHANGER

(71) Applicant: Brazeway, Inc., Adrian, MI (US)

(72) Inventors: Vikas SOMANI, Sylvania, OH (US); Alfred WANG, Adrian, MI (US)

(21) Appl. No.: 15/889,331

(22) Filed: Feb. 6, 2018

Related U.S. Application Data
(60) Provisional application No. 62/456,742, filed on Feb. 9, 2017.

(51) Int. Cl. B23K 35/28; F28D 7/00; F28F 21/08; C22C 21/00; C22F 1/04

(52) U.S. Cl. CPC B23K 35/288; F28D 7/0066; B23K 2201/06; C22C 21/00; C22F 1/04; F28F 21/084

(57) ABSTRACT

An aluminum alloy for heat exchanger applications and a method for fabricating a billet comprising the aluminum alloy are disclosed. The aluminum alloy includes an amount of silicon between 0.01 and 0.08 wt %; an amount of iron between 0.03 and 0.12 wt %; an amount of manganese 0.50 and 0.90 wt %; an amount of titanium 0.1 and 0.15 wt %; an amount of zinc between 0.05 and 0.10 wt %; no more than 0.03 wt % copper; no more than 0.008 wt % nickel; no more than 0.03 wt % other impurities; and a balance of aluminum. The ratio of iron and silicon to manganese ranges from 0.044 to 0.40, and the total wt % of zinc and titanium is between 0.15 and 0.25 wt %. Fabrication of the billet includes heating and soaking the billet to a temperature between 575° C. and 625° C. and cooling the billet to 350° C. at a controlled rate between 100° C. and 225° C. per hour.

### CROSS-REFERENCE TO RELATED APPLICATIONS

This application claims priority to U.S. Provisional Application No. 62/456,742, filed on Feb. 9, 2017. The entire disclosure of the above application is incorporated herein by reference.

### FIELD

The present disclosure relates to a tube formed from an aluminum alloy that has improved high-temperature brazing performance and excellent corrosion resistance, and to a heat exchanger formed from a plurality of the tubes.

### BACKGROUND

This section provides background information related to the present disclosure which is not necessarily prior art.

Aluminum tubing is used in brazed heat exchangers for residential, commercial, and automotive heating and cooling applications. Hollow aluminum round tubes are typically formed by extrusion, drawing, or welding. Aluminum alloys that are commonly used to construct the aluminum tubes include 1xxx and 3xxx series alloys.

The aluminum tubes are primarily fabricated in u-bend shapes called hairpins. To form a heat exchanger, several hairpins are inserted through a stack of stamped aluminum thin sheets called fins. Subsequently, a mandrel is used to mechanically expand the hairpins, which increases the surface area contacting the fins. After expansion, other tubes are metallurgically joined with the hairpins using a brazing process to form a closed loop (e.g., conduit for refrigerant flow). Typical braze filler alloys used during the brazing process include aluminum-silicon or aluminum-zinc alloys.

Silicon-based braze fillers have activation temperatures that range between 560° C. and 580° C., while 1xxx and 3xxx series aluminum alloys have solidus (e.g., melting) temperatures between 635° C. and 655° C. Accordingly, tight control of the temperature profile during brazing is essential to prevent leaks that result from melting (e.g., burn-through) of the aluminum tubes. Burn-through cannot be visually detected and requires specialized leak identification tests and procedures, increasing the complexity and cost of coil fabrication.

Burn-through has been avoided by brazing at lower temperatures. However, low-temperature brazing negatively impacts productivity and causes various other quality issues. Accordingly, there exists a need for an aluminum alloy that is less prone to burn-through during brazing.

### SUMMARY

This section provides a general summary of the disclosure, and is not a comprehensive disclosure of its full scope or all of its features.

The present disclosure provides an aluminum alloy, comprising silicon (Si) in an amount ranging from 0.01 to 0.08 wt %; iron (Fe) in an amount ranging from 0.03 to 0.12 wt %; manganese (Mn) in an amount ranging from 0.50 to 0.90 wt %; titanium (Ti) in an amount ranging from 0.1 to 0.15 wt %; zinc (Zn) in an amount ranging from 0.05 to 0.10 wt %; copper (Cu) in an amount less than 0.03 wt %; nickel (Ni) in an amount less than 0.008 wt %; other impurities in an amount less than 0.03 wt %; and a balance of aluminum (Al), wherein a ratio of iron in combination with silicon to manganese ((Fe+Si):Mn) ranges from 0.044 to 0.40, and a total wt % of zinc in combination with titanium (Zn+Ti) is between 0.15 wt % and 0.25 wt %.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIGS. 1A-1C are photographs of grain microstructures of alloys produced according to the present disclosure, after the alloys were subjected to chemical etching;

FIGS. 2A-2C are photographs of tube surfaces after being exposed to a temperature of 650° C., wherein FIGS. 2A and 2B are photographs of tubes formed from an alloy according to the present disclosure, and FIG. 2C is a photograph of a tube formed from a conventional 3003 aluminum alloy;

FIG. 3A-3C are photographs of tube surfaces after being exposed to a temperature of 655° C., wherein FIGS. 3A and 3B are photographs of tubes formed from alloys according to the present disclosure, and FIG. 3C is a photograph of a tube formed from a conventional 3003 aluminum alloy;

FIGS. 4A-4D are photographs of cross-sections of aluminum tubes after being exposed to elevated temperatures, wherein the tube in FIG. 4A is formed of a conventional 3003 alloy that was exposed to a temperature of 650° C., the tube in FIG. 4B is formed of a conventional 3003 alloy that was exposed to a 655° C. temperature, the tube in FIG. 4C is formed of an alloy according to the present disclosure that was subjected to a temperature of 655° C., and the tube in FIG. 4D is formed of another alloy according to the present disclosure that was exposed to a temperature of 655° C.

FIGS. 5A-5D are scanning electron microscope (SEM) images showing the microstructures of aluminum alloys, wherein FIGS. 5A, 5B, and 5D are alloys according to the present disclosure and FIG. 5C is a conventional 3003 aluminum alloy;

FIG. 6 is a graph that illustrates the maximum pit depth measurements of alloys produced according to the present disclosure after SWAAT testing; and

FIGS. 7A and 7B are photographs showing the grain structures of alloys produced according to the present disclosure after 35 days of SWAAT testing.

Corresponding reference numerals indicate corresponding parts throughout the several views of the drawings.

### DETAILED DESCRIPTION

Example embodiments will now be described more fully with reference to the accompanying drawings.

Pure aluminum (99.99%) has a melting point of 660.2° C. Aluminum-silicon alloys used as braze fillers have melting points that range between about 575° C. and about 582° C. The brazing temperature window for operators to achieve a leak free aluminum tube comprising high purity aluminum, therefore, is about 80° C. It should be noted, however, that alloying additives that are used to improve the strength, formability, and corrosion resistance of the aluminum alloy lower the melting point of the aluminum alloy and, consequentially, narrow the brazing window. Further, alloying additives such as iron and silicon may form intermetallic particles in the alloy, which narrows the brazing window even further because of the comparatively low melting temperature of the intermetallic particles.

Traditionally, tight control of the temperature profile during brazing has been essential to the prevention of burn-through and associated leaks. However, burn-through may still occur when the brazing temperatures are kept well below the melting point of the braze filler. In particular, intermetallic phases usually have lower melting points than the aluminum alloy grain matrix resulting in segregation of intermetallic particle zones (e.g., interconnected voids) prone to the formation of voids after high temperature exposure during brazing. The interconnected voids may result from localized melting of low melting temperature intermetallic phases along the grain boundaries of the aluminum alloy. The present disclosure provides an aluminum alloy that resists burn-through and a homogenization process that results in a reduction of the interconnecting of the intermetallic phases along the grain boundaries.

First, an extrudable aluminum alloy is provided. The aluminum alloys may have compositions having the following elements in the following ranges in weight percent (wt %): an amount of silicon (Si) that is greater than or equal to about 0.01 wt % and less than or equal to about 0.08 wt %; an amount of iron (Fe) that is greater than or equal to about 0.03 wt % and less than or equal to about 0.12 wt %; an amount of manganese (Mn) that is greater than or equal to about 0.50 wt % and less than or equal to about 0.90 wt %; an amount of titanium (Ti) that is greater than or equal to about 0.1 wt % and less than or equal to about 0.15 wt %; an amount of zinc (Zn) that is greater than or equal to about 0.05 wt % and less than or equal to about 0.10 wt %; an amount of copper (Cu) that is less than or equal to about 0.30 wt %; an amount of nickel (Ni) that is less than or equal to about 0.008 wt %; an amount of inevitable impurities that is less than or equal to about 0.03 wt %; and a balance of aluminum (Al). The total weight percent of zinc in combination with titanium is greater than or equal to about 0.15 wt % and less than or equal to about 0.25 wt %. The inevitable impurities are impurities inherent in the processing of aluminum and aluminum compositions and include, for example only, gallium (Ga) and carbon (C).

Controlling the amounts of silicon and iron in the brazing alloy is critical to the prevention of the formation of intermetallic phases along grain boundaries. The ratio of iron in combination with silicon to manganese ranges between 0.044 and 0.40. Further, a low iron content reduces susceptibility of the brazing alloy to pitting corrosion. Additionally, a manganese content between 0.50 wt % and 0.90 wt % provides the brazing alloy with adequate corrosion resistance and improved extrudability. Comparatively, a zinc content between 0.05 wt % and 0.10 wt % provides corrosion resistance without negatively affecting extrudability. A titanium content between 0.10 wt % and 0.15 wt % further improves the corrosion resistance of the brazing alloy. Further, the content of nickel is maintained such that it does not negatively affect cost of the braze alloy or its corrosion properties.

Table 1 lists exemplary alloy compositions according to the present disclosure in weight percent. It should be understood that each exemplary alloy includes a balance of aluminum.

TABLE 1
Alloy Billet Compositions

| Alloy Name | Si | Fe | Mn | Zn | Ti | Ni | Cu |
|---|---|---|---|---|---|---|---|
| A | 0.15 | 0.11 | 0.85 | 0.08 | 0.12 | 0.00 | 0.00 |
| B | 0.08 | 0.08 | 0.81 | 0.07 | 0.12 | 0.01 | 0.00 |

Alloy A includes 0.15 wt % silicon; 0.11 wt % iron; 0.85 wt % manganese; 0.08 wt % zinc; 0.12 wt % titanium; and a balance of aluminum. Alloy B includes 0.08 wt % silicon; 0.08 wt % iron; 0.81 wt % manganese; 0.07 wt % zinc; 0.12 wt % titanium; 0.01 wt % nickel; and a balance of aluminum. The alloys are casted to form aluminum billets or ingots.

For subsequent comparison only, Table 2 lists the elemental composition of conventional 3003 aluminum alloy. It should be understood that a maximum weight percent is denoted and that the conventional 3003 alloy also includes a balance of aluminum.

TABLE 2
Conventional 3003 Alloy Composition

| Alloy Name | Si | Fe | Mn | Zn | Ti | Ni | Cu |
|---|---|---|---|---|---|---|---|
| 3003 | 0.60 | 0.70 | 1.0-1.5 | 0.15 | 0.05 | 0.05 | 0.05-0.20 |

The conventional 3003 alloy includes 0.60 wt % silicon; 0.70 wt % iron; between 1.0 wt % and 1.5 wt % manganese; 0.15 wt % zinc; 0.05 wt % titanium; 0.05 wt % nickel; between 0.05 wt % and 0.20 wt % copper; and a balance of aluminum.

Second, billets cast from the above-noted compositions are homogenized. The homogenization process affects the microstructures of the alloys and, therefore, has a critical role in extrudability of the alloy and its post-fabrication grain structure. Homogenization of the aluminum alloy composition according to the disclosure results in a low-cost braze alloy that has improved high-temperature brazing performance (i.e., burn-through resistance) and excellent corrosion resistance and optimal extrudability. Homogenization of the casted aluminum billets is performed to attain a consistent composition across the billet width, break macro segregation, and control of the solute quantity within the matrix of the braze alloy.

The homogenization process according to the disclosure is designed to control the size and amount of intermetallics such that the intermetallics are unable to form interconnected chains of low melting intermetallic phases at brazing temperature. In other words, proper homogenization limits the area covered by intermetallic particles, including precipitates and dispersoids, which prevents or at least substantially minimizes the formation of interconnected voids along the grain boundaries that result in burn-through leaks. For example, the homogenization process according to the disclosure limits the area covered by intermetallic particles to less than about 2% of the total area.

Homogenization of the casted aluminum billets generally includes heating the billets to an elevated temperature and soaking the billets for a predetermined period. Soaking temperatures and periods control the amount of alloying additives in solid solution with the matrix, and the amount and size of dispersoids precipitating out of the matrix. The solid solution and dispersoids are critical features influencing the extrudability, grain structure, corrosion resistance, and mechanical properties of the braze alloy.

The homogenization process includes heating the casted billets to temperatures ranging between about 560° C. and about 625° C. and soaking the billets at that temperature for several hours. The heated and soaked billets are subsequently cooled to room temperature, which also takes several hours.

Table 3 lists exemplary homogenization processes for billets having the alloy compositions depicted in Table 1.

TABLE 3
Homogenization Processes

| Alloy | Homogenization | % IACS Conductivity |
|---|---|---|
| A | 620° C. soak + controlled cool | 32-34 |
| B | 620° C. soak + controlled cool | 32-34 |
| C | 580° C. soak + controlled cool | 33-38 |

Billets formed with alloy A were heated and soaked for approximately 4 hours at a peak temperature of 620° C. The billets were then cooled at a controlled rate to room temperature The controlled rate may range from 75° C. per hour to 175° C. per hour. Billets formed from Alloy B were processed using two different homogenization practices. In the first instance, the billets were heated and soaked for 4 hours at a peak temperature of 620° C. and then cooled at a controlled rate to 350° C. The controlled rate may range from 100° C. per hour to 225° C. per hour. In the second instance, the billets were heated and soaked for 4 hours at a peak temperature of 580° C. and then cooled at a controlled rate to 350° C. Similar to the first instance, the controlled rate may range from about 100° C. per hour to about 225° C. per hour.

Conductivity of the billets is a measure of the amount of alloying elements in solid solution. Greater amounts of alloying elements result in lower conductivities, while lower amounts of alloying elements result in greater conductivities. In other words, if undesirable intermetallic particles form during formation of the alloy, the conductivity increases. As such, conductivity measurements are used to evaluate the effectiveness of homogenization. % IACS refers to the international annealed copper standard and 100% IACS is equivalent to a conductivity of 58.108 megasiemens per meter (MS/m) at 20° C.

Microstructural Evaluation

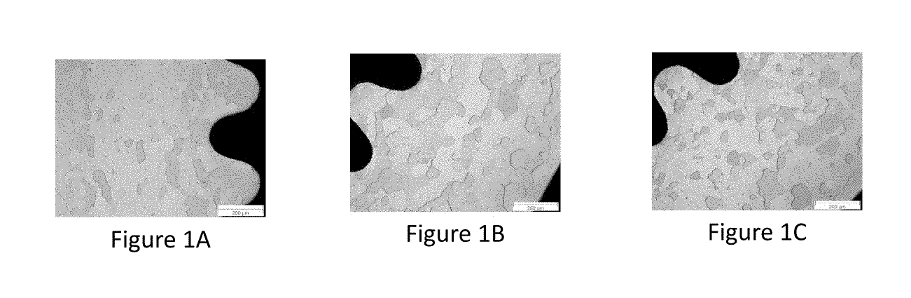

To evaluate properties in product form, the homogenized billets formed from alloys A, B, and C were extruded into round tubes. The tubes were mounted in epoxy and a metallographic examination was performed of each. FIG. 1A shows the grain structure of alloy A. FIG. 1B shows the grain structure of alloy B. FIG. 1C shows the grain structure of alloy C. In each, relatively few intermetallic particles were visible in the microstructure, and the area covered by the intermetallic phases and precipitates was less than about 2% of the total area.

Differential Scanning Calorimetry

A differential scanning calorimetry (“DSC”) test was conducted on alloys A, B, and C to identify transition and phase changes within the microstructure with increasing temperatures. To perform the test, a sample of each alloy, including a predetermined mass, was heated at a controlled rate of 10° C. per minute. For comparison, a sample of the conventional 3003 alloy was also heated. As the samples were heated, the change in heat flow for each was monitored. Table 4 tabulates the temperatures at which melting is first seen in the respective samples.

TABLE 4
DSC Melting Temperatures

| Alloy | Temperature (° C.) |
|---|---|
| A | 648 |
| B | 648 |
| C | 657 |
| 3003 | 646 |

As can be seen above, the conventional 3003 alloy has the lowest melting point. Alloys A, B, and C each have a melting point greater than the conventional 3003 alloy, which results in a lower chance of burn-through during brazing.

High Temperature Brazing Performance Tests

High temperature performance tests were performed on extruded round tube sections formed using alloys A, B, and C. The tests were also performed on tube sections formed using the conventional 3003 alloy. The test sections were exposed to elevated temperatures between about 650° C. and about 655° C. within an oven for one minute. The test sections were then inspected for surface condition and microscopically examined to determine the structure of grains and intermetallic particles.

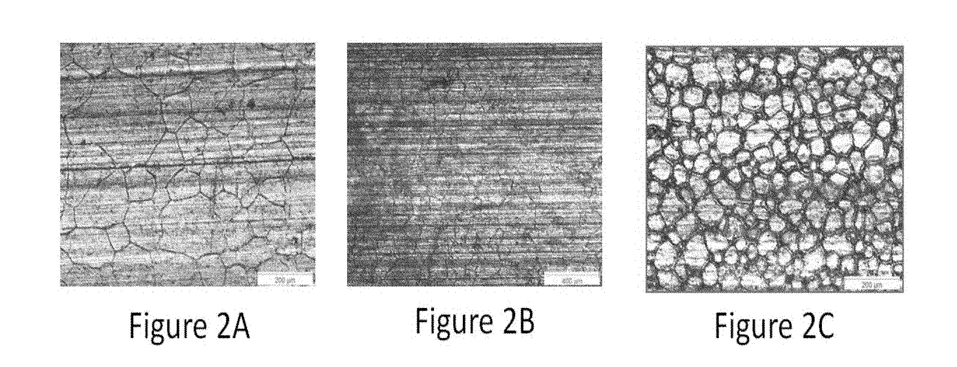

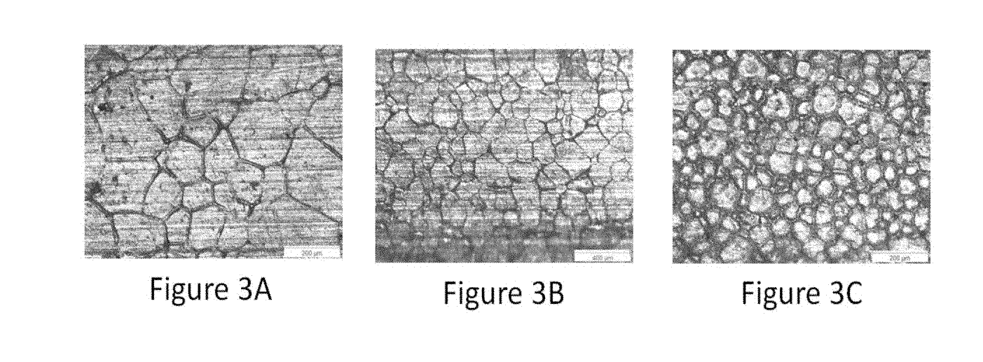

FIGS. 2A-2C are photographs of the tube surfaces after exposure to a temperature of about 650° C. FIGS. 3A-3C are photographs of the tube surfaces after exposure to a temperature of about 655° C. In FIGS. 2C and 3C, the tubes were formed from the conventional 3003 alloy, and wide open grain boundaries can be seen, which indicates that the 3003 alloys were severely affected by exposure to the elevated temperatures. In FIGS. 2A and 3A, the tubed were formed from alloy B, and in FIGS. 2B and 3B the tube was formed from alloy C. The tubes formed from alloys B and C clearly have minimal grain boundary segregation, which evidences that the formation of low temperature melting phases is reduced in alloys according to the present disclosure.

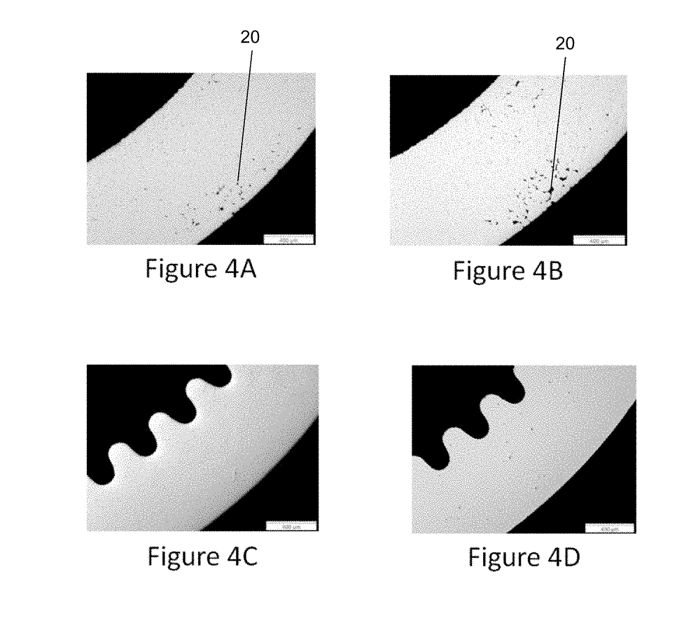

FIG. 4A shows the cross-sectional microstructure of a tube formed from the conventional 3003 alloy after exposure to a temperature of about 650° C., and FIG. 4B shows the cross-sectional microstructure of a tube formed from the conventional 3003 alloy after exposure to a temperature of about 655° C. As can be seen in FIGS. 4A and 4B, the tube includes interconnected voids 20 that are undesirable. Comparatively, FIG. 4C is a cross-section of a tube formed from alloy B after being exposed to a temperature of about 655° C., and FIG. 4D is a cross-section of a tube formed from alloy C after being exposed to a temperature of about 655° C. As clearly seen in FIGS. 4C and 4D, tubes that are formed from alloys according to the present disclosure are devoid of interconnected voids.

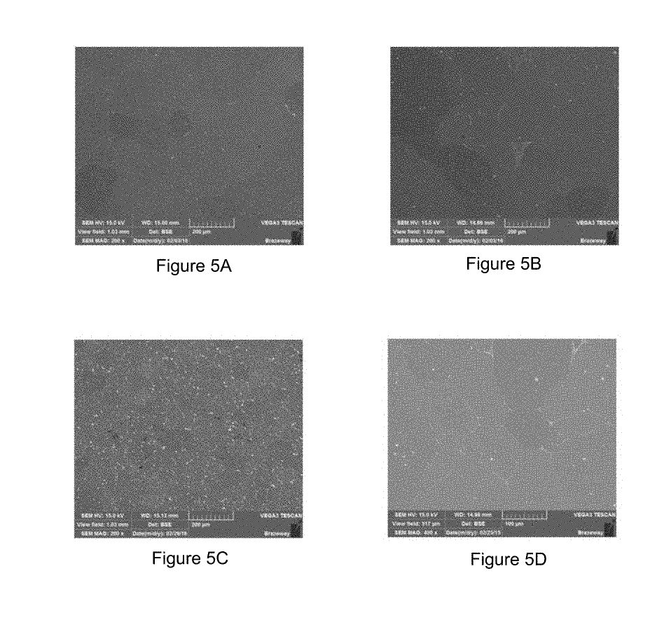

Similarly, FIGS. 5A-5D are scanning electron microscope images that show the microstructure of tubes formed from alloys A (FIG. 5A), B (FIG. 5B), and C (FIG. 5D) according to the present disclosure and a conventional 3003 alloy (FIG. 5C) after being exposed to a temperature of about 655° C. As can be seen in these images, the alloys according to the present disclosure contain fewer intermetallic particles and less grain boundary segregation in comparison to the conventional 3003 alloy.

Accelerated Corrosion Tests

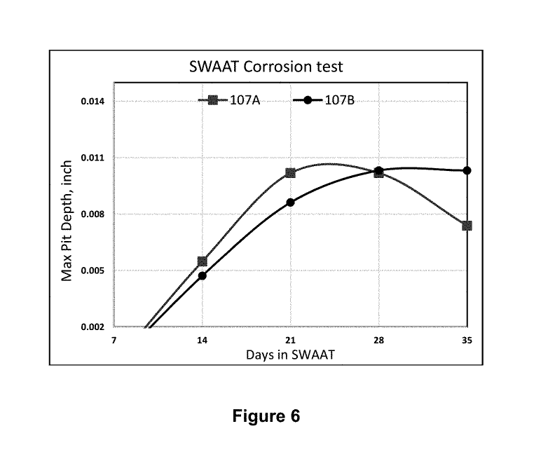

Multiple twelve inch coupons formed from alloys B and C were tested using a SWAAT (ASTM G85-A3) corrosion test. Coupons were removed from the test at various points and evaluated for maximum pit depth and corrosion mode. Coupons were removed after 14, 21, 28, and 35 days. FIG. 6 graphically illustrates the maximum pit depths measured within the respective coupons after SWAAT testing. Corrosion depth plateaued for each of alloy B and alloy C after 21 to 28 days of SWAAT testing.

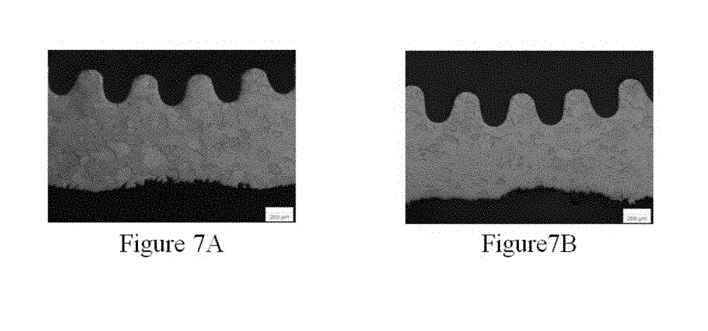

FIGS. 7A and 7B are images of grain structures of the coupons formed from alloys B and C after 35 days of SWAAT testing. FIG. 7A shows grain structure of alloy B, and FIG. 7B shows the grain structure of alloy C. The grain structures for alloys B and C show a lateral corrosion mode with corrosion progressing sideways along the surface. The lateral corrosion mode is desirable because it protects against wall leakage when the aluminum tubes are exposed to a corrosive environment. The plateau of FIG. 6 confirms the lateral corrosion phenomenon.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An aluminum alloy, comprising:
silicon (Si) in an amount ranging from 0.01 to 0.08 wt %;
iron (Fe) in an amount ranging from 0.03 to 0.12 wt %;
manganese (Mn) in an amount ranging from 0.50 to 0.90 wt %;
titanium (Ti) in an amount ranging from 0.1 to 0.15 wt %;
zinc (Zn) in an amount ranging from 0.05 to 0.10 wt %;
copper (Cu) in an amount less than 0.03 wt %;
nickel (Ni) in an amount less than 0.008 wt %;
other impurities in amount less than 0.03 wt %; and
a balance of aluminum (Al),
wherein a ratio of iron in combination with silicon to manganese ((Fe+Si):Mn) ranges from 0.044 to 0.40, and a total wt % of zinc in combination with titanium (Zn+Ti) is between 0.15 wt % and 0.25 wt %.

2. The aluminum alloy of claim 1, wherein the alloy has a conductivity (% IACS) between 32 and 38.

3. The aluminum alloy of claim 1, wherein the aluminum alloy has a melting point of about 657° C.

4. A method of manufacturing an aluminum alloy billet, comprising:
forming an aluminum alloy;
casting the aluminum alloy into a billet;
homogenizing the billet by heating the billet to a temperature between 575° C. and 625° C.;
soaking the billet at the temperature; and
cooling the billet at a controlled rate to 350° C.

5. The method of claim 4, wherein the aluminum alloy comprises:
silicon (Si) in an amount ranging from 0.01 to 0.08 wt %;
iron (Fe) in an amount ranging from 0.03 to 0.12 wt %;
manganese (Mn) in an amount ranging from 0.50 to 0.90 wt %;
titanium (Ti) in an amount ranging from 0.1 to 0.15 wt %;
zinc (Zn) in an amount ranging from 0.05 to 0.10 wt %;
copper (Cu) in an amount less than 0.03 wt %;
nickel (Ni) in an amount less than 0.008 wt %;
other impurities in amount less than 0.03 wt %; and
a balance of aluminum (Al).

6. The method of claim 5, wherein a ratio of iron in combination with silicon to manganese ((Fe+Si):Mn) ranges from 0.044 to 0.4.

7. The method of claim 5, wherein a total wt % of zinc in combination with titanium (Zn+Ti) is between 0.15 wt % and 0.25 wt %.

8. The method of claim 4, wherein the controlled rate includes cooling the billet at a rate ranging between 75° C. and 225° C. per hour.

9. The method of claim 4, wherein the billet has a conductivity (% IACS) between 32 and 38.
